(19) United States
(12) Patent Application Publication
(10) Pub. No.: US 2003/0080867 A1
(43) Pub. Date: May 1, 2003

(54) Security device and intrusion-alarm system

(75) Inventor: Ramon Maria Rusinol Simon, Gerona (ES)

Correspondence Address: OSTROLENK FABER GERB & SOFFEN, 1180 AVENUE OF THE AMERICAS, NEW YORK, NY, 100368403

(73) Assignee: S.D.P. Sistemas De Proteccion, S.L.

(21) Appl. No.: 10/202,303

(22) Filed: Jul. 22, 2002

(30) Foreign Application Priority Data
Oct. 25, 2001 (ES) 200102368

(51) Int. Cl. G08B 13/00

(52) U.S. Cl. 340/541; 340/539; 340/507

(57) ABSTRACT

A security device for an intrusion-alarm system, which comprises: radio-frequency detection means (10); means (11) for generating a signal indicating a possible sabotage, when the radio-frequency detection means detect a radio frequency over a defined time; means (12) for detecting an intrusion-indicating condition; means (13) for generating an intrusion-indicating signal when the means for detecting an intrusion-indicating condition detect an intrusion-indicating condition; and means (14) for generating an alarm-raising signal, in the event that the signal indicating a possible sabotage and the intrusion-indicating signal are generated. The invention also relates to an intrusion-alarm system which comprises such a device.

### FIELD OF THE INVENTION

The invention is encompassed in the field of intrusion-alarm systems.

### BACKGROUND OF THE INVENTION

Intrusion-alarm systems are known which are intended to detect an intruder and to generate a corresponding alarm, with the aim of surprising the intruders and/or of making it possible to detain them. This type of “anti-theft” system, provided as much for domestic as well as industrial use, for example in industrial parks, etc, may include a number of peripheral or accessory devices. The peripheral devices may include intrusion detectors, for example, volumetric detectors (which may be based, for example, on infrared, ultrasonic and/or microwave detectors), perimeter detectors (for example, electrical switches, photoelectric cells), etc, as well as alarm-signal generators, for example, independently powered external sirens (that is to say, sirens equipped with an energy source, with a view to not being dependent on the integrity of the general electrical supply network), telephone dialers (devices which are programmed such that, when they receive an alarm-raising signal, they dial a preprogrammed telephone number and transmit a message to an addressee, for example, to an alarm center of a security company), etc. All the peripheral devices can be connected to a central base in which information is received from the detectors and from which signals are sent for raising an alarm to the alarm-signal generating peripheral devices.

In traditional systems, the peripheral devices are connected to the central base by means of multi-way cables, such that the installation of an alarm system requires the corresponding installation of cables, which, in its turn, implies the corresponding costs and practical difficulties of installation. That being so, the traditional cable system may turn out to be unattractive, especially when it relates to an installation in which some peripheral devices have to be installed at a considerable distance from the central base.

In order to solve the problem of the cabling, alarm systems have been designed in which the peripheral devices and the central base include means for communication between said peripheral devices and the central base via coded signals which are transmitted by radio waves (at radio frequency). In one conventional system of this type, the central base includes means for receiving radio-frequency signals and means for decoding a coded signal received by said receiving means. The intrusion detectors include radio-frequency signal transmitters, which send out signals coded on the basis of a detected condition. The base station has means for establishing, on the basis of the decoded signals received, whether an alarm condition exists and, if said alarm system does exist, activating at least one device for generating an alarm signal. The device for generating the alarm signal, which may be an external siren or a telephone dialer, may have available means for receiving an alarm-raising signal from the central base, by radio waves and/or by other means.

All the peripheral devices may include batteries which guarantee them a degree of independence from an external energy source.

The majority of these types of systems work at defined radio-transmission frequencies. In fact, in the European Union, a standard exists which establishes the frequencies at which these systems can work, that is to say, the frequencies for radio communication between the peripheral devices and the central base, and it is prohibited to market alarm systems of this type which operate at other frequencies (normally, the permitted frequency is 433.92 MHz; it is probable that a new permitted frequency will shortly be established, possibly around 900 MHz).

Logically, this implies a risk, since it could be quite easy to sabotage the system by way of an attack on the communications channels between the peripheral devices and the central base. In concrete terms, knowing the frequencies at which the signals are transmitted between the peripheral devices and the central base, it is possible to generate a distortion signal at the same frequency or the same frequencies (for example, at the frequency of 433.92 MHz), with the intention that the central base will not receive the signals emitted by the intrusion detectors correctly and/or with the intention that the devices generating an alarm signal will not receive correctly the signals for activation of an alarm sent from the central base. In fact, in order to be able to put a system of this type out of service, it may be sufficient to actuate a remote control which uses the same frequency as the alarm system (for example, the frequency of 433.92 MHz).

Systems exist on the market in which an attempt has been made to overcome this problem, adding a frequency detector which, when it detects a prolonged signal at the frequency at which the system operates, it generates an alarm. Unfortunately, these types of systems frequently generate false alarms, since any prolonged signal at the frequency at which the system operates can generate an alarm signal.

### DESCRIPTION OF THE INVENTION

The invention relates to a device in accordance with claim 1 and to a system in accordance with claim 7. Preferred embodiments of the invention are defined in the dependent claims.

In accordance with the invention, the device comprises:

radio-frequency detection means;

means for generating a signal indicating a possible sabotage, when the radio-frequency detection means detect a radio frequency over a defined time;

means for detecting an intrusion-indicating condition;

means for generating an intrusion-indicating signal when the means for detecting an intrusion-indicating condition detect an intrusion-indicating condition; and

means for generating an alarm-raising signal, in the event that the signal indicating a possible sabotage and the intrusion-indicating signal are generated.

The radio-frequency detection means advantageously consist of a conventional radio-frequency detector. The radio-frequency detection means can be configured to detect a set frequency (for example, the frequency at which an alarm system incorporating the device operates, for example the frequency of 433.92 MHz) or any frequency within a range of frequencies.

The means for generating a signal indicating a possible sabotage, when the radio-frequency detection means detect a radio frequency over a defined time, may consist of a logic circuit associated with the radio-frequency detection means and configured in such a way that, when a radio-frequency signal is detected for a period longer than a defined threshold, it changes the level of a logic output, for example from “0” to “1”.

The means for detecting an intrusion-indicating condition may consist of any conventional device capable of detecting an intrusion condition, for example one or more infrared, ultrasonic, optical, microwave, electromagnetic, etc, detectors. It preferably uses a subsonic or vibration sensor, that is to say, a vibration detector intended to detect the vibrations created by an intruder. However, the means for detecting an intrusion-indicating condition may also consist of other types of detectors, including a combination of detectors of different types, for example, of a combination of “active” detectors (which send out signals and which, for example, receive reflections of said signals against nearby objects) and “passive” detectors (which detect vibrations caused by an intruder, infrared radiation emitted by him or her, etc), which generate signals which are analyzed separately and/or in combination. Logically, the sensitivity of the means for detecting an intrusion-indicating condition (thresholds, frequency intervals to be detected, etc.) is preferably set up on the basis of the particular conditions of each case, for example, on the basis of the area or volume of the protected area, of the level of ambient noise, etc.

The means for generating an intrusion-indicating signal when the means for detecting an intrusion-indicating condition detect an intrusion-indicating condition may consist of a simple logic circuit associated with the means for detecting an intrusion-indicating condition; when said detection means detect the intrusion-indicating condition (for example, subsonic vibrations (for example, at a frequency of between 0.2 and 2 Hz) caused by an intruder), the means for generating an intrusion-indicating signal can change the level of the logic output, for example from “0” to “1”. Nevertheless, the means for generating an intrusion-indicating signal may also include means for carrying out a more complex analysis of signals originating from the means for detecting an intrusion-indicating condition, for example, means for carrying out an analysis of signals originating from various detectors and, depending on the results of said analysis, for generating the intrusion-indicating signal. For example, the analysis may include an analysis of signals picked up by a subsonic detector and of signals picked up by a heat or infrared radiation detector, and the intrusion-indicating signal could be generated, for example, if, within a defined period of time which follows a detection of vibrations (caused, for example, by the opening of a door and/or window) the presence of an object with a temperature higher than a predetermined threshold is detected (which may be indicative of the presence of a human being).

The means for generating an alarm-raising signal in the event of the signal indicating a possible sabotage and the intrusion-indicating signal being generated may consist of a logic circuit connected to the logic outputs mentioned above. For example, said means for generating an alarm-raising signal may consist of a simple “AND” logic gate with two inputs and one output; the two inputs can be coupled to the two logic outputs mentioned above. That being so, when said two outputs change their logic level “0” to “1”, the output of said “AND” logic gate also changes logic level, from “0” to “1”, independently of which of the two outputs has changed level first. The change from “0” to “1” of the output of said “AND” logic gate may constitute the alarm-raising signal. This signal is applied to a device for generating an alarm signal, for example, to an independently-powered siren which will emit the corresponding alarm sound, to a telephone dialer which dials the number of an alarm center or of a security firm, etc.

The means for generating a signal indicating a possible sabotage when the radio-frequency detection means detect a radio frequency over a defined time, the means for generating an intrusion-indicating signal when the means for detecting an intrusion-indicating condition detect an intrusion-indicating condition and the means for generating an alarm-raising signal in the event of the signal indicating a possible sabotage being generated and the intrusion-indicating signal being generated, are preferably produced as an electronic module which incorporates or which is coupled to the radio-frequency detection means and to the means for detecting an intrusion-indicating condition, and which has an output available on which the alarm-raising signal appears. Said output may be connected to a peripheral generating an alarm signal (for example, to an independently-powered siren which will emit the corresponding alarm sound, to a telephone dialer which dials the number of an alarm center, of a security firm, etc), or to an appropriate input of a central base of an alarm system, in such a way that the alarm-raising signal applied to said input causes the central base, in its turn, to generate the signals necessary for generating an alarm signal (by means of a siren, telephone dialer, etc).

Logically, all the above-mentioned means may be implemented in many ways, based on conventional components which exist on the market. The end product is a device which generates an alarm when a radio-frequency signal which complies with defined conditions (for example, which has an amplitude higher than a defined threshold and/or a defined duration and/or which includes one or more defined frequencies) and an intrusion-indicating condition (for example, subsonic vibrations caused by an intruder) are detected simultaneously (or within a defined time interval). Logically, it is not always strictly necessary for the radio frequency and the intrusion-indicating condition to be detected simultaneously; the device may be configured in such a way that the signal for raising the alarm is generated if the radio frequency and the intrusion-indicating condition are detected at a defined time interval (for example, if a radio frequency is detected first during a time t₁, and a time t₂ after the detection of the radio frequency has ceased, the intrusion-indicating condition is detected, t₂ being less than a defined threshold).

The intrusion-alarm system in accordance with the invention is based on a conventional system which comprises:

at least one intrusion-detector peripheral which includes:

means for detecting an intrusion-indicating condition; and

means for sending a coded signal to a central base, by radio frequency, when an intrusion-indicating condition is detected; and

a central base which includes:

means for receiving a coded signal from an intrusion-director peripheral, by radio frequency; and

means for generating an alarm-raising signal, on the basis of the received coded signal.

In accordance with the invention, said system also includes a security device in accordance with what was explained above. This security device can be coupled to a conventional system as a module which is separate from it, or can be integrated into the system. For example, the logic circuits of the security device can be produced in integrated form with the logic circuits of the central base of the system.

In this way, the invention is applicable both to already-existing conventional systems as well as to future systems, in which the device is preferably integrated into the systems.

### BRIEF DESCRIPTION OF THE DRAWINGS

A description is given below, very briefly, of a series of drawings which assist in giving a better understanding of the invention and which are expressly related to preferred embodiments of said invention, which are presented as illustrative but non-limiting examples thereof.

FIG. 1 is a block diagram which reflects a system in accordance with a preferred embodiment of the invention.

FIG. 2 is a block diagram which, in schematic form, reflects a device in accordance with a preferred embodiment of the invention.

FIG. 3 illustrates, schematically, a device in accordance with a preferred embodiment of the invention coupled to a conventional central alarm base.

### DESCRIPTION OF PREFERRED EMBODIMENTS OF THE INVENTION

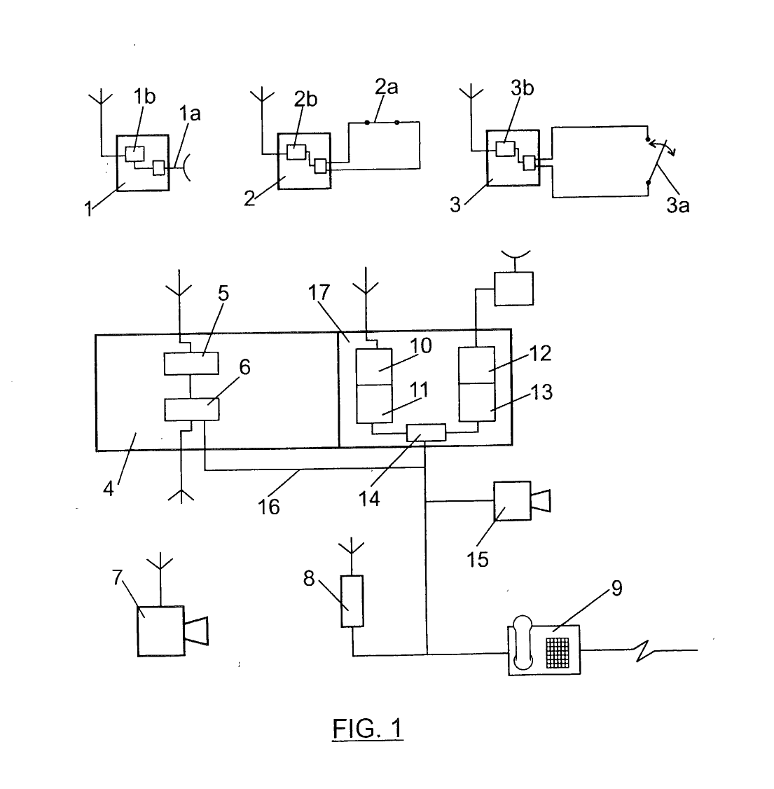

FIG. 1 reflects an intrusion-alarm system which comprises a subsonic intrusion-detector peripheral (1) which includes a vibrations detector (1a), a perimetral detector peripheral (2) which includes an electric circuit (2a), the breaking or cutting of which (due, for example, to the opening of a door or window) is interpreted as an indication of an intrusion, and the perimetral detector peripheral (3) which includes an electrical circuit (3a) the closing of which (due, for example, to the operation of a door or similar) is interpreted as an intrusion-indicating condition. These three detector peripherals (1, 2, 3) are equipped with the corresponding means (1b, 2b, 3b) for sending a coded signal to a central base (4) by radio frequency, when an intrusion-indicating condition is detected. The radio frequency used can be of 433.92 MHz.

The system further includes said central base (4), which includes means (5) for receiving the coded signals from the intrusion-detector peripherals (1, 2, 3) by radio frequency; and means (6) for generating an alarm-raising signal, on the basis of the coded signal received. Said alarm-raising signal may be sent, by radio frequency, to an independently-powered siren (7) and directly, via a wire conductor (6), to an independently-powered siren (15) and to the telephone dialer (9).

The system also includes a security device (17) which comprises: the radio-frequency detection means (10), the means (11) for generating a signal indicating a possible sabotage when the radio-frequency detection means (10) detect a radio frequency over a defined time; the means (12) for detecting an intrusion-indicating condition; the means (13) for generating an intrusion-indicating signal when the means (12) for detecting an intrusion-indicating condition detect an intrusion-indicating condition; and the means (14) for generating an alarm-raising signal in the event that the signal indicating the possible sabotage and the intrusion-indicating signal are generated.

The radio-frequency detection means (10) are configured to detect a signal with a frequency which corresponds to a frequency for communication between the intrusion-detector peripherals (1, 2, 3) and the central base, for example a frequency of 433.92 MHz.

The means (12) for detecting an intrusion-indicating condition comprise a vibrations detector, which is preferably configured to detect subsonic vibrations, at frequencies of 0.2-2 Hz, for example.

The means (14) for generating an alarm-raising signal are connected to an output which communicates with the independently-powered siren (15) and with the telephone dialer (9) and, moreover, with a radio-frequency transmitter (8) by means of which the alarm-raising signal can be transmitted to the independently-powered siren (7) by radio waves, for the purpose of activating said siren in the event of an alarm.

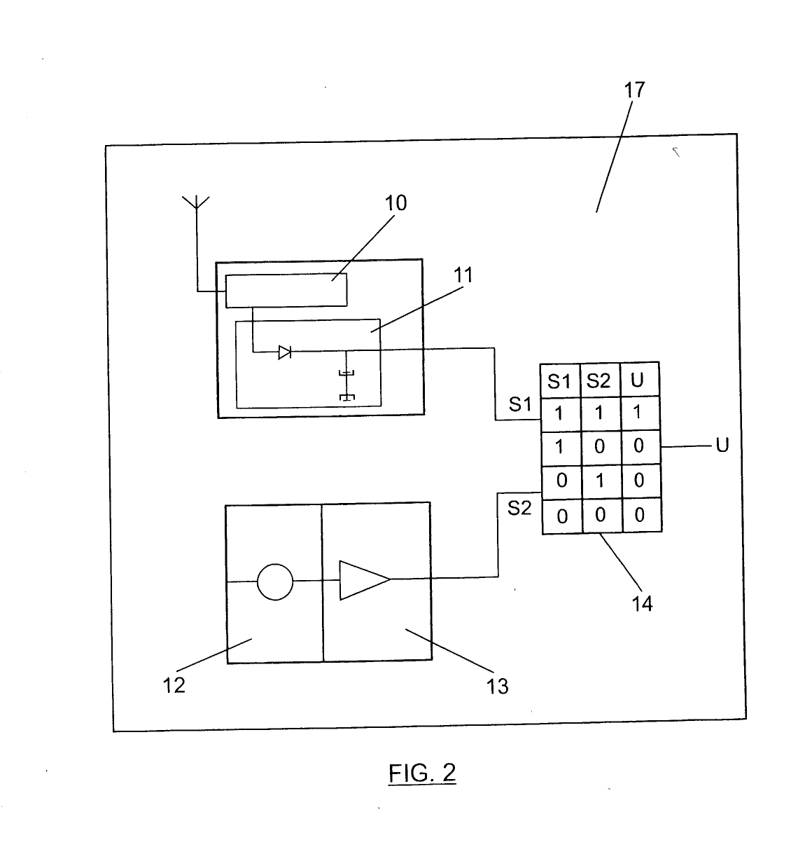

FIG. 2, in schematic form, illustrates the configuration of a preferred embodiment of the security device (17), in which it can be seen how said device includes, on one hand, the radio-frequency detection means (10) and the means (11) for generating a signal (S1) indicating a possible sabotage, and, on the other hand, the means (12) for detecting an intrusion-indicating condition (in this case, a simple microphone sensitive to subsonic vibrations) and the means (13) for generating an intrusion-indicating signal (S2) when the means (12) for detecting an intrusion-indicating condition detect an intrusion-indicating condition (in this case, subsonic vibrations, for example, in the interval 0.2-2 Hz). Moreover, it can be seen, in schematic form, how the means (14) for generating an alarm-raising signal are configured as the logic circuit which generates an alarm-raising signal in the event that the signal indicating a possible sabotage and the intrusion-indicating signal are generated. The signal indicating a possible sabotage (S1), the intrusion-indicating signal (S2) and the alarm-raising signal (U) correspond to defined signal levels at outputs from logic components of a logic circuit; in this case, the signals signaled correspond to the logic level “1”; when S1=1 (signal indicating possible sabotage) and S2=1 (intrusion-indicating signal), the alarm-raising signal (U=1) is generated.

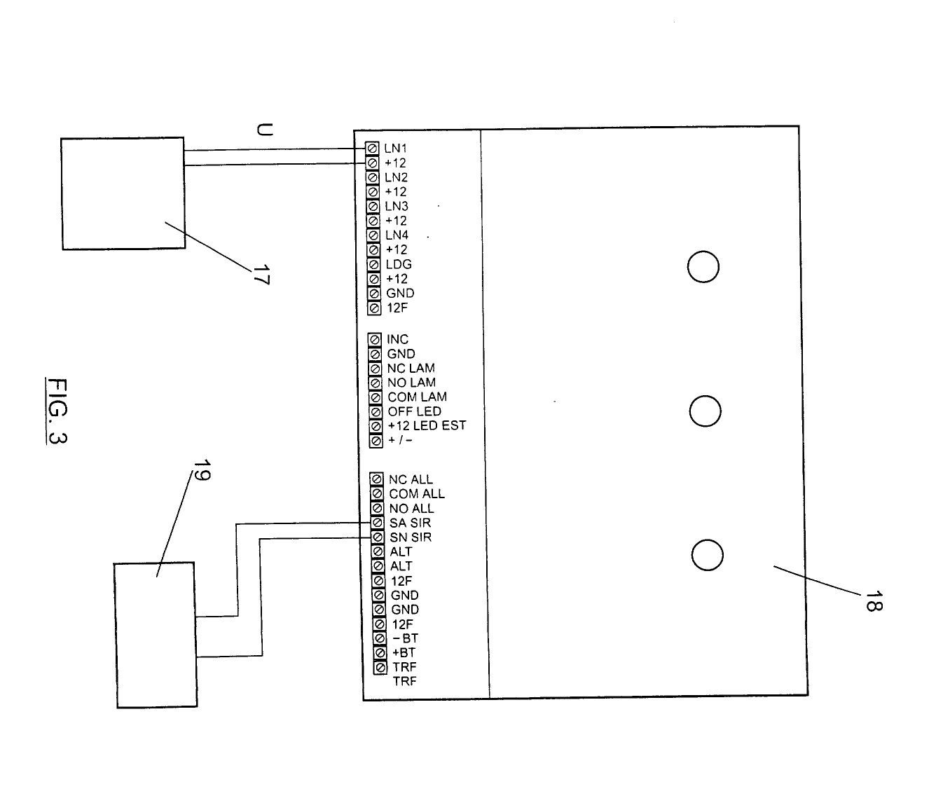

FIG. 3 illustrates, in schematic form, how the device of the invention (17) in accordance with another preferred embodiment of the invention, is coupled to a conventional central alarm base (18). In this case, the device does not comprise a direct connection to the alarm-generating peripherals (sirens, etc), but the output of the signal U for activating an alarm from the device (17) is connected to an input (LN1) of the central alarm base which, in its turn, is connected to a siren (19), in such a way that an alarm-raising signal U=1 activates the siren (19) via said central base (18).

Logically, the selection of components and their arrangement will be capable of variation, as long as no alteration is intended to the basic concept of the invention.

What is claimed is

1. A security device for an intrusion alarm system, which comprises:
a radio frequency detector; a first signal generator which acts on a signal from the radio frequency detector for generating a first signal when the radio frequency detector detects a radio frequency for a time period greater than a defined time period;
a second detector capable of detecting an intrusion indicating condition; a second signal generator which acts on a signal from the second detector for generating an intrusion indicating signal;
a third alarm raising signal generator which is operated upon the first signal generator generating a first signal and the second signal generator generating an intrusion indicating signal.

2. The security device of claim 1, wherein the radio frequency detector is configured to detect a signal frequency at which security devices typically transmit information related to detected intrusions.

3. The device of claim 2, wherein the radio frequency detector is configured to detect a signal with a frequency of 433.92 MHz.

4. The security device of claim 1, wherein the second detector for detecting an intrusion indicating condition comprises a vibrations detector.

5. The security device of claim 1, wherein the third alarm raising signal generator and the second intrusion indicating signal generator are arranged such that an alarm raising signal is generated when the radio frequency detector detects a radio frequency for a period of time greater than the defined time period, and the intrusion indicating condition detector detects an intrusion condition and the detected radio frequency and the intrusion condition coincide in time.

6. The security device of claim 1, wherein the third alarm raising signal generator and the second signal generator are arranged so that the third alarm raising signal generator generates a signal and the second signal generator generates a signal such that the third alarm raising signal is generated when the radio frequency detector detects a radio frequency for longer than a defined time and generates a first signal, and the second signal generator generates a second signal and the first and second signals are both produced within a defined period of time.

7. The device of claim 1, further comprising a logic circuit with outputs at which defined signal levels are defined; the first signal generator, the second signal generator and the third signal generator are connected with the logic circuit; and the first signal, the intrusion indicating signal and the alarm raising signal correspond to defined signal levels at outputs from logic components of the logic circuit.

8. An intrusion alarm system including a security device according to claim 1;
the alarm system further comprising:
at least one intrusion detector peripheral which includes a third detector for detecting a second intrusion indicating condition and a transmitter for sending a coded signal to a central base by radio frequency when the second intrusion indicating condition is detected;
a central base comprising a signal receiver adapted to receive the coded signal by radio frequency when the second intrusion indicating condition is detected by the third detector and the coded signal is sent to the base;
a fourth alarm raising signal generator being operable by a received coded signal at the central base.

9. The intrusion alarm system of claim 8, further comprising an alarm device and wherein the fourth alarm raising signal generator of the alarm system is adapted to transmit an alarm raising signal to the alarm device which generates an alarm.

10. The intrusion alarm system of claim 9, wherein the alarm device comprises at least one of an independently powered siren and a telephone dialer for dialing a telephone number.

11. The intrusion alarm system of claim 10, wherein the third alarm raising signal generator of the security device is adapted to transmit an alarm raising signal to at least one of a telephone dialer, and an independently powered siren, or to dial a programmed telephone number.

12. The intrusion alarm system of claim 8, wherein the third alarm raising signal generator of the security device is adapted to transmit an alarm raising signal to at least one of a telephone dialer, and an independently powered siren, or to dial a programmed telephone number.

13. The security alarm system of claim 8, wherein the radio frequency detector is adapted to detect a signal with a standard frequency used to communicate between the at least one intrusion detector peripheral and the central base.
